(19) United States
(12) Patent Application Publication
(10) Pub. No.: US 2006/0044270 A1
(43) Pub. Date: Mar. 2, 2006

(54) Wireless input device containing compartment for receiving additional device

(76) Inventor: Zhi-Ping Chen, San Chong (TW)

Correspondence Address: Raymond Sun, Suite 155, 20 Corporate Park, Irvine, CA, 92606, US

(21) Appl. No.: 10/871,713

(22) Filed: Jun. 17, 2004

(51) Int. Cl. G09G 5/08

(52) U.S. Cl. 345/163

(57) ABSTRACT

A wireless input device has a housing having a first compartment and a micro switch housed therein, a power supply retained in the first compartment, and a top cover removably coupled to the housing for covering the power supply. The top cover has at least one free extension formed in one piece with the top cover, with the free extension depressed to activate the micro switch. The input device can also include a wireless receiver retained inside a second compartment inside the housing.

### BACKGROUND OF THE INVENTION

1. Field of the Invention

The present invention relates to an input device, and in particular, to a wireless input device having a compartment for receiving additional devices, such as batteries, a wireless receiver, a pen drive (portable storage device with flash memory inside), and similar devices.

2. Description of the Prior Art

Input devices such as computer mice, track balls, joysticks, and game controllers, are becoming essential devices when a user wishes to operate a computer system or the like, so as to accomplish their daily work, communicate with others or entertain themselves. However, no matter how small the input device is, a cable is always required, and occupies space on the often limited working space on a desk, often tangling with the stationery and other computer peripheral devices.

Due to the advancements made in wireless technology, most input devices are becoming wireless. Despite this trend to go wireless, a power supply, such as a battery, is still necessary for powering the wireless input device. U.S. Pat. Nos. 6,225,981 and 6,411,281 illustrate examples of conventional wireless input devices, where an extra cover is provided behind the buttons for holding batteries within the wireless input device. Unfortunately, the structures in these two patents are restricted to the whole outline design of the input device because of the complex button constructions coupled to the upper housings.

In addition, once a user carries a wireless input device outside an office or a home, how and where would the user store the wireless receivers? These wireless receivers will become lost sooner of later if there are stored in briefcases or other bags. Similarly, the recently popular miniaturized portable storage devices, such as pen drives, require a place to be carefully and safely stored.

### SUMMARY OF THE DISCLOSURE

It is an object of the present invention to provide a wireless input device that includes a compartment for receiving batteries.

It is another object of the present invention to provide a wireless input device that includes a compartment for receiving wireless receivers.

It is yet another object of the present invention to provide the wireless input device that includes a compartment for receiving a portable storage device.

In order to accomplish the objects of the present invention, there is provided a wireless input device that has a housing having a first compartment and a micro switch housed therein, a power supply retained in the first compartment, and a top cover removably coupled to the housing for covering the power supply. The top cover has at least one free extension formed in one piece with the top cover, with the free extension depressed to activate the micro switch. The input device can also include a wireless receiver retained inside a second compartment inside the housing.

### BRIEF DESCRIPTION OF THE DRAWINGS

FIG. 1 is an exploded perspective view of one embodiment of an input device according to the present invention.

FIG. 2 is an exploded perspective view of the input device of FIG. 1.

FIG. 3 is an assembled perspective view of the input device of FIG. 1.

FIG. 4A-4D are side plans views illustrating the assembling of the top cover of the input device of FIG. 1.

FIGS. 5A and 5B are exploded perspective views of the input device of FIG. 1 showing the installation of the battery and the wireless receiver.

FIG. 6A is an exploded perspective view of another embodiment of an input device according to the present invention.

FIG. 6B is an assembled perspective view of the input device of FIG. 6A.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

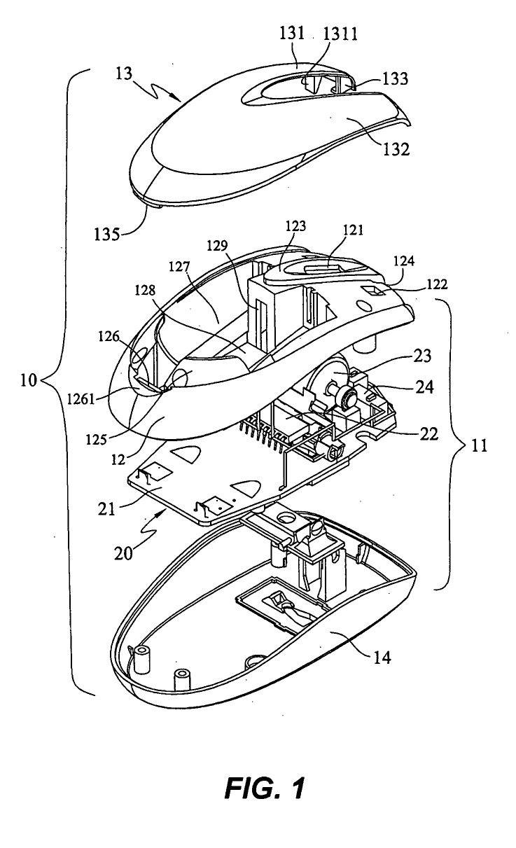

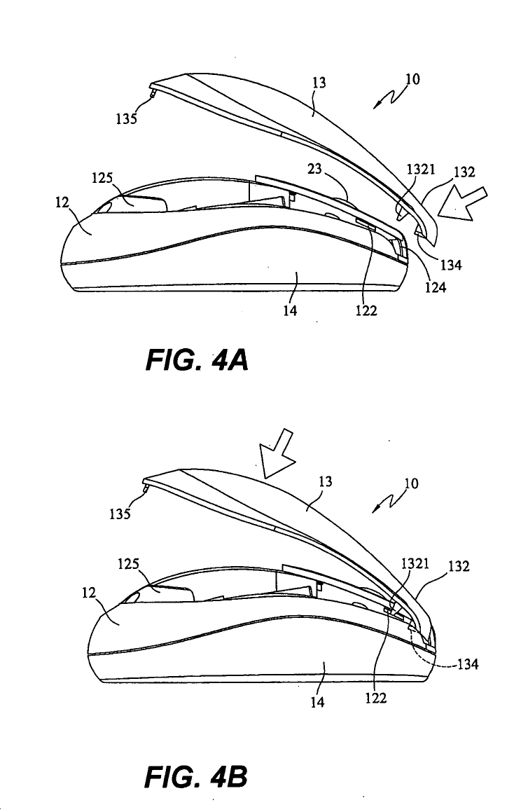

FIGS. 1-3 illustrate the input device 10 according to the present invention, which can be embodied as a computer mouse, a track ball, or other similar device. The input device 10 as shown in FIGS. 1-5B can be a wireless mouse. The input device 10 has a housing 11 which further includes an upper housing 12, a lower housing 14, and a top cover 13. An electric component 20 is provided, and may include a PCB 21 (printed circuit board), a coordinate detection module 22, a roller 23 and two micro switches 24 for operating the input device. These components can be found in all conventional wireless input devices.

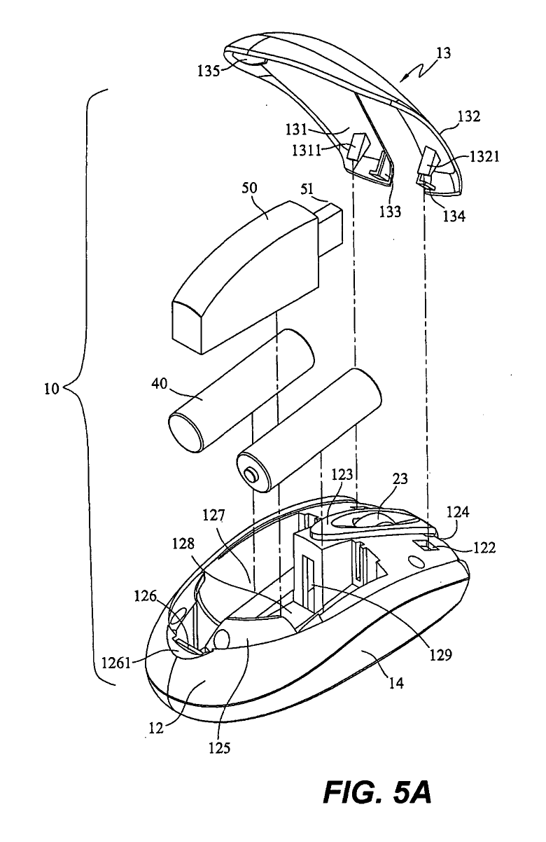

The upper housing 12 has an opening 121 surrounded by a ridge 123. The opening 121 receives the upright roller 23. The upper housing 12 also has two holes 122 for respectively exposing the micro switches 24 to the button portions 131 and 132 of the top cover 13. The upper housing 12 also includes a surface 125, two first compartments 127 for receiving a battery 40 each (see FIG. 5A), and a second compartment 128 for receiving a wireless receiver 50.

The top cover 13 is mounted upon the upper housing 12, and has at least a free extension that is formed in one piece with the top cover 13. Each free extension can be a button that is depressable towards a corresponding micro switch. For example, the cover 13 has two free button portions 131 and 132 that extend along the sides of the protrusion 123. Each button portion 131, 132 can be depressed by a user so as to activate a corresponding micro switch 24 within the housing 11. Each button portion 131 and 132 has a hook 133 and 134, respectively, at a front end such that each hook 133 and 134 can hook a corresponding recess 124 provided at a front end of the upper housing 12. In addition, each button portion 131 and 132 has an arm 1311 and 1321, respectively, which penetrates a corresponding hole 122 for activating a corresponding micro switch 24. A wedge 135 is provided at the rear end of the cover 13 to be inserted into a groove 126 in the upper housing 12 for a close-fit configuration.

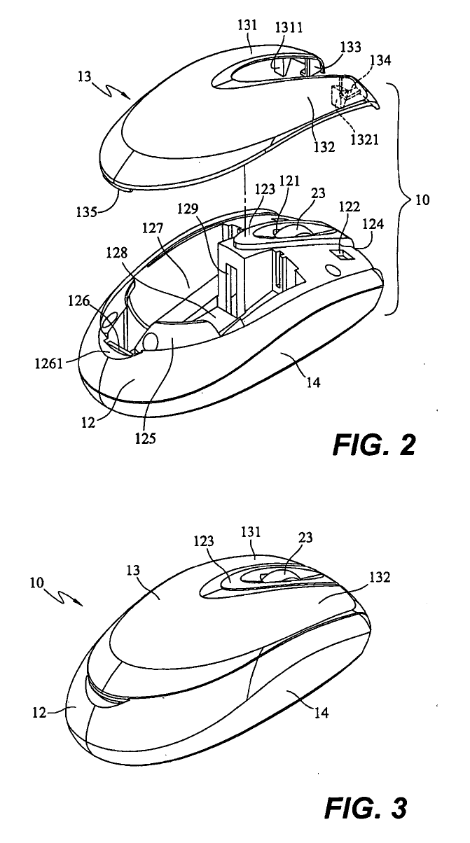

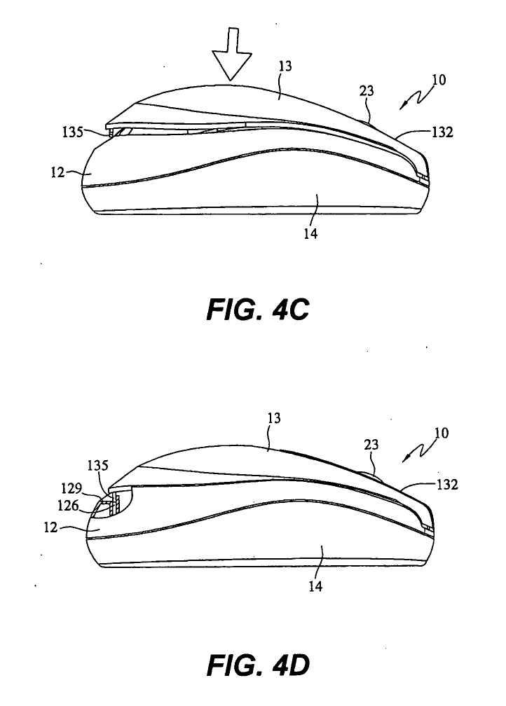

FIGS. 4A-4D illustrate the operation of the top cover of the input device 10. Once the upper housing 12 is firmly coupled to the lower housing 14 by any known connection mechanisms (e.g., screws), then the top cover 13 can be further placed over the upper housing 12 according to the following steps. First, each hook 133 and 134 of the button portions 131 and 132 hooks a corresponding recess 124 located at a front end of the upper housing 12. Second, each arm 1311 and 1321 of the button portions 131 and 132, respectively, is forced backwardly into the corresponding hole 122. Third, the wedge 135 at the rear end of the cover 13 is downwardly forced to insert it into the groove 126 in a close-fit configuration so as to secure the cover 13 upon the upper housing 12. If the user wishes to detach the cover 13, then the user can simply lift the cover 13 from a recess 1261 (see FIGS. 1 and 2) provided at the rear side of the groove 126. Once the user presses the button portion 131 or 132, the corresponding arm 1311 or 1321 will activate the corresponding micro switch 24.

Referring now to FIGS. 5A and 5B, the user can place a battery 40 at each first compartment 127 for operating the wireless input device 10. If the user wishes to carry the input device 10 away from its normal location of use, then the user can place the wireless receiver 50 into the second compartment 128. In order to secure the receiver 50 firmly, an opening 129 may be provided in the top housing 12 adjacent the second compartment 128 for receiving the connector 51 of the receiver 50. Therefore, the top cover 13 can be a button, a top cover (housing), or a battery cover. In addition, a portable storage device, such as a pen drive, can be positioned in the second compartment 128 for being carried outdoors together with the input device 10.

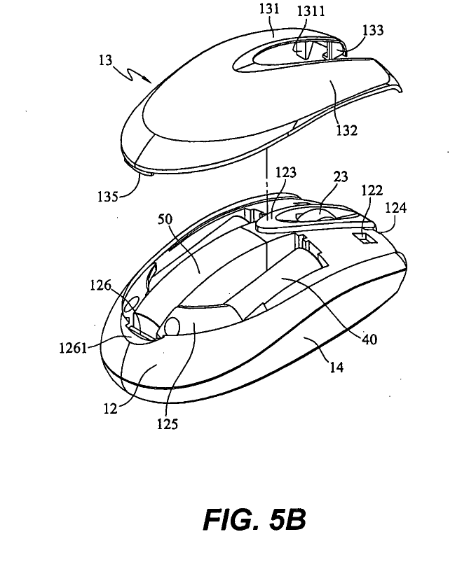

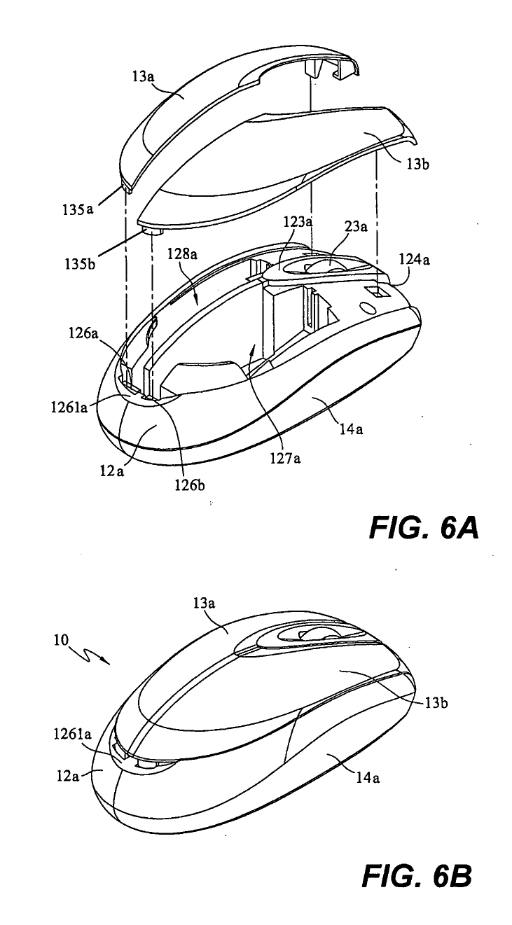

FIGS. 6A-6B illustrate another embodiment of an input device 10a according to the present invention, where the top cover 13 can be designed as two individual button portions 13a and 13b. The user can detach the button portions 13a and 13b separately by lifting each from the recess 1261a. Also, each button portion 13a and 13b can be secured by inserting a corresponding wedge 135a and 135b, respectively, into a corresponding groove 126a and 126b, respectively. However, it is appreciated that the locations, sizes, and shapes of the first and second compartments 127a and 128a can be varied anywhere inside the input device 10a. The elements in FIGS. 6A-6B that are the same as the elements in FIGS. 1-5B are designated by the same numeral designations, except that the designations in FIGS. 6A-6B include an “a”, so further description of these elements will not be repeated herein.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A wireless input device, comprising:
a housing having a first compartment and a micro switch housed therein;
a power supply retained in the first compartment; and
a top cover removably coupled to the housing for covering the power supply, the top cover having at least one free extension formed in one piece with the top cover, with the free extension depressed to activate the micro switch.

2. The device of claim 1, further including:
a second compartment inside the housing; and
a wireless receiver retained inside the second compartment.

3. The device of claim 2, wherein the wireless receiver is a portable storage device.

4. The device of claim 1, wherein the top cover has a wedge, and the housing has a corresponding groove for receiving the wedge.

5. The device of claim 1, wherein the top cover is shaped as a fork having two free extensions.

6. The device of claim 1, wherein the free extension is a control button.

7. The device of claim 1, wherein the top cover has two separate button portions, with each button portion comprised of a free extension.

8. The device of claim 1, wherein the free extension has an arm for activating the corresponding micro switch.

9. The device of claim 1, wherein the extension has a hook for securing a recess of the housing.
